(19) United States
(12) Patent Application Publication
(10) Pub. No.: US 2011/0268051 A1
(43) Pub. Date: Nov. 3, 2011

(54) SYSTEM AND METHOD FOR CONTROLLING WLAN AND BLUETOOTH COMMUNICATIONS

(75) Inventors: Wei-sung Tsao, Fremont, CA (US); Paul Petrus, San Jose, CA (US)

(73) Assignee: Atheros Communications, Inc., San Jose, CA (US)

(21) Appl. No.: 12/956,782

(22) Filed: Nov. 30, 2010

Related U.S. Application Data
(60) Provisional application No. 61/328,848, filed on Apr. 28, 2010.

(51) Int. Cl. H04W 72/04; H04B 7/00

(52) U.S. Cl. 370/329; 455/41.2

(57) ABSTRACT

This disclosure involves methods and systems for controlling WLAN and Bluetooth communications by allocating bandwidth into times blocs having a first segment with Bluetooth priority and a second segment with WLAN priority. Access to the wireless communication medium is signaled over an interface connecting the WLAN and Bluetooth modules. Downlink traffic is modulated by signaling the WLAN access point to buffer traffic during the first segment. WLAN traffic can also be modulated by allowing reception and blocking transmission WLAN signals during the first segment. Further, while high priority Bluetooth transmission are preferably always allowed, low priority Bluetooth transmission can be restricted during the second period, depending upon the respective states of the WLAN and Bluetooth modules. A coexistence agent can be used to transfer relevant information between the WLAN and Bluetooth modules.

### RELATED APPLICATIONS

This application relies on provisional application Ser. No. 61/328,848 filed on Apr. 28, 2010.

### FIELD OF THE PRESENT INVENTION

The present disclosure generally relates to wireless communications and more particularly relates to systems and methods for enhancing the coexistence of WLAN and Bluetooth networks.

### BACKGROUND OF THE INVENTION

The recent proliferation of devices employing wireless communication technologies requires careful design to minimize interference and improve the quality of service. For example, Bluetooth and wireless local area network (WLAN) communication systems are often implemented in a single device.

Bluetooth is often used to connect and exchange information between mobile phones, computers, digital cameras, wireless headsets, speakers, keyboards, mice or other input peripherals, and similar devices. Bluetooth allows for the creation of a personal area network (PAN) between a master and up to seven slaves. For many Bluetooth applications, it is necessary to ensure the uninterrupted delivery of correctly ordered data packets.

WLAN systems, such as those defined by IEEE 802.11 protocols, are typically directed to longer range communications and larger networks. WLAN communications provide relatively high data rates over relatively long distances, offering an easy interface to existing network infrastructures. As such, the nature of a significant portion of WLAN traffic makes it less susceptible to packet order and delivery time problems.

Although WLAN communications operate on an asynchronous protocol and access the wireless medium using a Carrier Sense Multiple Access/Collision Avoidance (CSMA/CA) mechanisms while Bluetooth communications rely on time division multiplex access (TDMA) mechanisms, both share the 2.4 GHz Industrial, Scientific and Medical Device band (ISM) band. As a result, interference between the two communications systems can occur. This problem is exacerbated by the physical collocation of the systems when both are implemented in a single device. Indeed, current trends are moving from each system being carried on separate integrated circuits to merging both onto a single chip. Further, given the difference in the typical nature of the WLAN and Bluetooth communications, certain Bluetooth links need to be given priority in order to guarantee the necessary quality of service.

Recognizing the potential for interference, various techniques have been employed to improve coexistence. A primary strategy relies on the frequency hopping aspects of the Bluetooth devices. The WLAN communication tends to park, having a center at one frequency and width within the spectrum while the Bluetooth devices “hop” around, transmitting or receiving over 625 μs time slots on one of the 79 available 1 MHz bands before switching to another channel. Once interference is detected, adaptive frequency hoping (AFH) techniques allow the Bluetooth devices to avoid the Bluetooth channels that overlap the WLAN channel.

Although AFH offers significant performance gains, the out-of-band Bluetooth signal can still affect WLAN signals, especially when the systems are collocated. Typically, the WLAN system is receiving packets from a relatively more distant access point, increasing the chance that the WLAN front end will be saturated by the Bluetooth transmissions. Therefore, it is desirable to minimize or eliminate the amount of simultaneous WLAN and Bluetooth traffic. One strategy for achieving this goal relies on a hardwired interface between the two systems that allows for packet traffic arbitration (PTA) depending upon the activity of each system. As will be recognized by one of skill in the art, examples of PTA protocols include 2-wire, 3-wire and 4-wire systems. Each of these protocols involve the Bluetooth device communicating its state to the WLAN device and the WLAN device arbitrating the channel use based on these input states and its own states. As such, the WLAN and Bluetooth devices time-share usage of the 2.4 GHz band.

Depending upon the implementation, the PTA protocols provide information to the WLAN system about the activity of the Bluetooth system, the relative priority level of the Bluetooth information, and whether Bluetooth is transmitting on a restricted channel. Based upon the information received over the PTA connection, the WLAN system will arbitrate usage of the communication systems by either signaling over the PTA interface that the WLAN is active, which disables Bluetooth communications during that period, or that the WLAN is inactive, which allows Bluetooth communications.

The use of PTA protocols further minimizes interference between the WLAN and Bluetooth systems. However, even though the WLAN system has information about the presence and nature of ongoing Bluetooth communications, there are still coexistence problems with these protocols. In particular, PTA schemes are less effective at protecting downlink traffic compared to uplink traffic.

For example, when there is high priority Bluetooth activity, hardware aborts any current WLAN traffic, treating it as an internal collision. Enforcing this quality of service is necessary for many types of Bluetooth communications as discussed above; however, it can significantly increase WLAN packet losses. Knowledge of Bluetooth activity allows the WLAN system to minimize these effects on uplink traffic. However, these transmission failures cause the access point to revert to lower transmit rate, significantly degrading the downlink throughput. Furthermore, since the access point has no knowledge that the Bluetooth traffic is causing the transmission failures, the access point keeps retrying the failed frame at a lower rate, taking more air-time and significantly adding to the probability of interference with Bluetooth traffic.

Accordingly, what has been needed is a system and method for implementing WLAN and Bluetooth communications that minimizes interference. For example, there is a need to provide a system and method that is configured to protect downlink WLAN traffic while still ensuring a quality of service necessary for Bluetooth communications. This disclosure is directed to these and other needs.

### SUMMARY OF THE INVENTION

In accordance with the above needs and those that will be mentioned and will become apparent below, this disclosure is directed to a method for controlling WLAN and Bluetooth communications including providing a device having a WLAN module with a hardware portion, a Bluetooth module with a hardware portion, and a packet traffic interface between the WLAN hardware portion and the Bluetooth hardware portion, dividing available communication bandwidth into time blocs, allocating bandwidth in a time bloc into a first segment and a second segment, assigning priority to Bluetooth communication for the first segment and assigning priority to WLAN communication for the second segment, and signaling wireless access to the Bluetooth hardware portion through the interface during the first segment.

In one aspect, the method also includes modulating WLAN communication by signaling a WLAN access point to buffer transmission during the first segment. Preferably, this involves sending a power save signal. In another aspect, the method includes modulating WLAN communication by allowing reception of WLAN signals and blocking transmission of WLAN signals during the first segment.

Preferably, allocating bandwidth is based upon information regarding Bluetooth links or upon the state of the WLAN module and Bluetooth module. Also preferably, wireless access to the Bluetooth hardware portion is signaled during the second segment so that high priority Bluetooth transmissions are allowed. Depending upon the respective states of the WLAN and Bluetooth modules, low priority Bluetooth transmissions are either allowed or not allowed during the second period.

In another aspect, the method also includes transferring information between a software portion of the WLAN module and a software portion of the Bluetooth module with a coexistence agent. Preferably, such information concerns the WLAN configuration state or a profile indicating the number and type of Bluetooth links.

This disclosure is also directed to an apparatus for controlling WLAN and Bluetooth communications including a device having a WLAN module with a hardware and software portion, a Bluetooth module with a hardware portion, and a packet traffic interface between the WLAN hardware portion and the Bluetooth hardware portion, wherein the WLAN software portion is configured to divide available communication bandwidth into time blocs, allocate bandwidth in a time bloc into a first segment and a second segment, assign priority to Bluetooth communication for the first segment and assign priority to WLAN communication for the second segment, and signal wireless access to the Bluetooth hardware portion over the interface during the first segment. Preferably, the WLAN software portion is further configured to modulate WLAN by signaling a WLAN access point to buffer transmission during the first segment, such as by sending a power save signal. Also preferably, the WLAN software portion signals the WLAN allocates bandwidth based upon information regarding Bluetooth links. The WLAN software portion can also allocate bandwidth based upon the state of the WLAN module and Bluetooth module. As desired, the WLAN software portion can also be configured to modulate WLAN communication by allowing reception of WLAN signals and blocking transmission of WLAN signals during the first segment.

In another aspect, the WLAN software portion is further configured to signal wireless access to the Bluetooth hardware portion over the interface during the second segment so that high priority Bluetooth transmissions are allowed. Depending upon the respective states of the WLAN and Bluetooth modules, the WLAN software portion is further configured to signal wireless access during the second segment so that low priority Bluetooth transmissions are either allowed or not allowed.

In yet another aspect, the apparatus also includes a coexistence agent configured to transfer information between the software portion of the WLAN module and a software portion of the Bluetooth module. The information transferred preferably includes information about the WLAN configuration state or information about the number and type of Bluetooth links.

### BRIEF DESCRIPTION OF THE DRAWINGS

Further features and advantages will become apparent from the following and more particular description of the preferred embodiments of the invention, as illustrated in the accompanying thawing, and in which like referenced characters generally refer to the same parts or elements throughout the views, and in which:

FIG. 1 is a schematic illustration of the architecture of a combined Bluetooth and WLAN communication system, according to the invention;

FIG. 2 is a representation of communication traffic, showing suppression of Bluetooth transmission to protect WLAN downlink traffic, according to the invention;

FIG. 3 is a schematic representation of one embodiment of successive allocations of time blocs by a bandwidth multiplexer, according to the invention; and

FIG. 4 is a schematic representation of 3-wire PTA protocol, used in an embodiment of invention.

### DETAILED DESCRIPTION OF THE INVENTION

At the outset, it is to be understood that this disclosure is not limited to particularly exemplified materials, architectures, routines, methods or structures as such may, of course, vary. Thus, although a number of such option, similar or equivalent to those described herein, can be used in the practice of embodiments of this disclosure, the preferred materials and methods are described herein.

It is also to be understood that the terminology used herein is for the purpose of describing particular embodiments of this disclosure only and is not intended to be limiting.

Unless defined otherwise, all technical and scientific terms used herein have the same meaning as commonly understood by one having ordinary skill in the art to which the disclosure pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise.

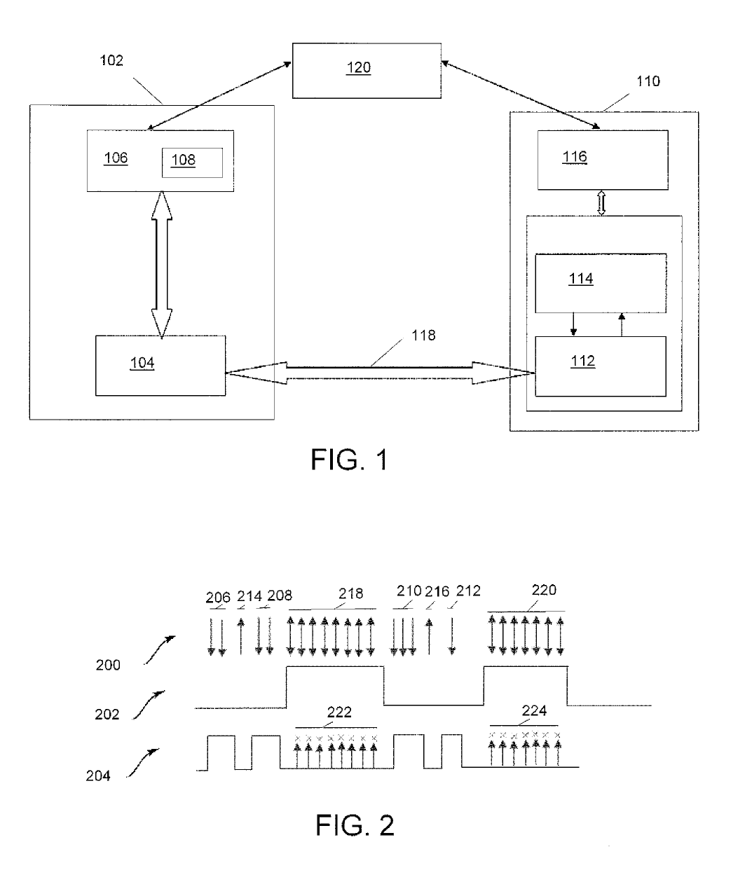

As discussed above, there is a need to provide systems and methods that allow efficient coexistence of WLAN and Bluetooth communication systems within a single device. As shown in FIG. 1, a suitable architecture 100 for the coexistence solutions of this disclosure is shown within a device having both WLAN and Bluetooth communication capabilities. Generally, a WLAN module 102 includes a hardware portion 104 and a software portion 106. As will be appreciated, software portion 106 contains the driver software necessary for communication between the device and the hardware portion 104. Software portion 106 also includes a bandwidth multiplexer 108, described in detail below. Similarly, a Bluetooth module 110 conventionally includes a hardware portion 112 and firmware portion 114 that communicate with Bluetooth stack software 116 resident on the device.

Packet traffic interface 118 connects WLAN hardware portion 104 and Bluetooth hardware portion 112 Further details regarding interface 118 are given below, and in one embodiment, interface 118 comprises a 3-wire PTA interface as known in the art. A software-based coexistence agent 120 is configured to pass information between the software portion 106 of the WLAN and the Bluetooth stack 116.

Coexistence agent 120 is an application software module that communicates useful information between the WLAN and Bluetooth systems. For example, Bluetooth profile information relating to the number and type of connected Bluetooth clients, start and end times for Bluetooth scanning and basic data rate (BDR) or extended data rate (EDR) capabilities are communicated to the WLAN system. As described below, bandwidth multiplexer 108 uses such information to set up time blocs and allocate usage between the WLAN and Bluetooth systems. Information about the WLAN configuration is also passed to the Bluetooth system. For example, the center frequency and channel width of the WLAN system is communicated to the Bluetooth system to help refine the AFH algorithm, to help avoid Bluetooth transmissions on channels that are likely to interfere with the spectrum used by the WLAN. Further details regarding the operation and implementation of coexistence agents is given in Co-pending U.S. patent application Ser. No. 12/633,150, filed Dec. 8, 2009, which is hereby incorporated by reference in its entirety.

Protecting the downlink traffic of the WLAN system can help improve the coexistence of Bluetooth and WLAN communications. As discussed above, the WLAN access point has no knowledge of Bluetooth traffic and will downgrade the transmission rate and consume correspondingly greater air-time if there are too many dropped packets. Accordingly, the systems and methods of this disclosure are directed to selectively suppressing, or “stomping,” Bluetooth transmissions during selected time periods to allow the WLAN traffic to recover the physical layer rate and avoid downgrading by the access point. Uplink WLAN traffic is also be facilitated during these time periods.

FIG. 2 schematically illustrates the effect of this functionality. The top row 200 indicates WLAN traffic with up arrows indicating uplink packets, down arrows indicating downlink traffic and bidirectional arrows indicating both. The middle row 202 designates the state of WLAN activity. The bottom row 204 designates the state of Bluetooth activity. Accordingly, when Bluetooth activity is asserted and WLAN activity is de-asserted, no WLAN uplink packets are allowed, but downlink packets, groups 206, 208, 210 and 212 can be received. When Bluetooth activity is de-asserted and WLAN activity is de-asserted, WLAN uplink packets 214 and 216 are allowed. Finally, when WLAN activity is asserted, all WLAN packets are allowed, groups 218 and 220 and Bluetooth transmissions, groups 222 and 224 ate stomped. As will be discussed below, all Bluetooth transmissions can be blocked during periods of WLAN activity or low priority transmissions can be blocked while allowing high priority transmission to continue to ensure a desired quality of service for certain Bluetooth applications.

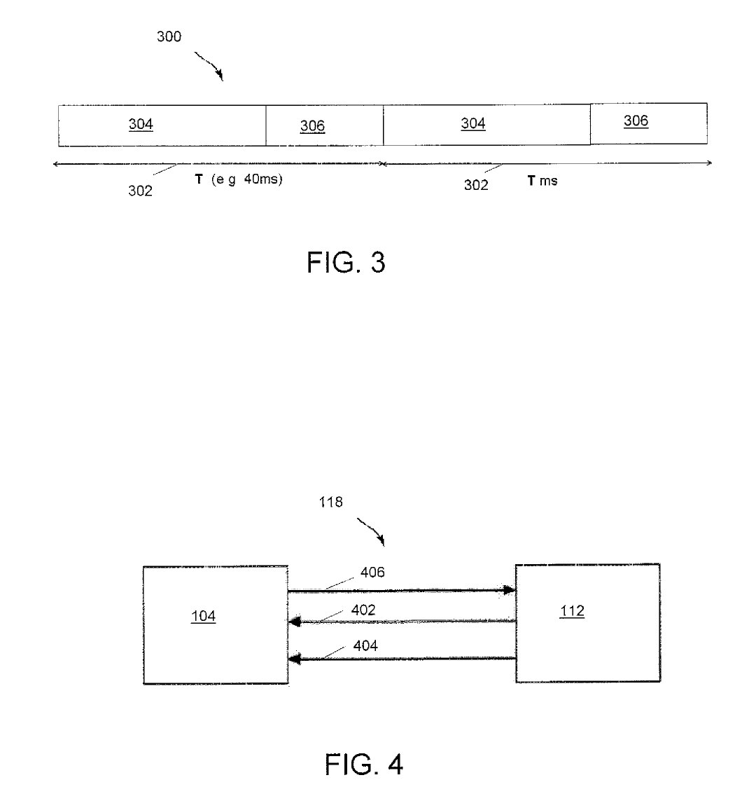

The behavior depicted in FIG. 2 is implemented by systems and methods of this disclosure using bandwidth multiplexer 108 to set up time blocs that allocate usage between WLAN and Bluetooth communication. Multiplexer 108 establishes blocs of time, preferably approximately 10 to 100 ms long, during which bandwidth is actively allocated between Bluetooth and WLAN. FIG. 3 depicts the operation of multiplexer 108, in which the bandwidth 300 is divided into time blocs 302, two of which are shown. In this embodiment, the time blocs are 40 ms long Within each block, the bandwidth is allocated between segment 304, which is reserved for Bluetooth communications, and segment 306, which is reserved for WLAN communications. As will be appreciated, any portion of segment 304 which goes unused due to Bluetooth inactivity can be filled by WLAN traffic. In the embodiment shown, segment 304 represents up to 70% of the bandwidth 300 in which Bluetooth is given priority and segment 306 represents 30% of the bandwidth 300 in which low priority Bluetooth communications will be stomped to protect WLAN downlink traffic. Even though segments 304 and 306 are shown as contiguous, one of skill in the art will realize that these are simply representations showing the relative percentage allocation of bandwidth. In practice, access between the WLAN and Bluetooth traffic may alternate repeatedly during each time bloc 302, but the overall allocation will correspond to the desired percentages.

Preferably, multiplexer 108 achieves the desired bandwidth allocation in part by controlling both downlink and uplink WLAN traffic. Multiplexer 108 modulates downlink traffic by signaling the WLAN access point to buffer transmissions for the amount of time corresponding to the desired bandwidth allocation. In a preferred embodiment, multiplexer 108 utilizes existing power saving protocols to achieve this signaling function. For example, multiplexer 108 can send a set power save (PS) bit to the access point, notifying it that transmissions should be held and then a clear PS bit to resume transmission. Unlike a conventional power save mode, the WLAN hardware 104 is kept awake so that no delay is introduced when the access point is signaled to restart transmission.

Optionally, during the period of time when the access point is holding transmission, multiplexer 108 can transmit a signal to the access point requesting transmission of a single flame when there is no conflicting Bluetooth activity. Correspondingly, multiplexer 108 modulates uplink WLAN traffic by limiting the aggregate length of WLAN transmission during the time bloc while allowing the scheduling of WLAN packets if the Bluetooth traffic is insufficient to consume the allocated bandwidth. It should also be noted that other strategies for signaling the access point related to legacy PSM (Power Save Mode), PS-Poll and Continually Awake Mode/Power Save Mode (CAM/PSM switching) or Unscheduled Asynchronous Power Save Delivery (U-APSD) can also be used.

As will be appreciated, it is desirable to adjust the bandwidth allocations performed by multiplexer to reflect the status of the WLAN and Bluetooth links. With regard to the WLAN system, there are four primary states: connected, disconnected, scanning and associating. Similarly, the Bluetooth system can be viewed as having three primary states: on, off and management. These potential states create twelve combinations of WLAN and Bluetooth states. For conditions when either WLAN is disconnected or Bluetooth is off, then no coexistence is necessary and multiplexer 108 allocates the entire bandwidth accordingly. The WLAN associating state is a relatively critical process, so it is preferable to skew bandwidth priority to the WLAN system during this state. On the other hand, the WLAN scanning state is less critical, so greater bandwidth can be allocated to the Bluetooth system. Further, the Bluetooth management state is also relatively less critical than the on state, so more bandwidth can be allocated to the WLAN system during Bluetooth management. Table 1 illustrates one example of a suitable bandwidth allocation scheme based upon WLAN and Bluetooth state, suitable for use with 40 ms time blocs.

TABLE 1

| | BT_ON | BT_OFF | BT_MGT |
|---|---|---|---|
| WLAN_CONNECT | Device dependent | Coex off | Stomp all/low |
| | | | (40/60) |
| WLAN_DISCONNECT | Coex off | Coex off | Coex off |
| WLAN_SCAN | Stomp low/no | Coex off | Stomp all/low |
| | (40/60) | | (40/60) |
| WLAN_ASSOC | Stomp all/low | Coex off | Stomp all/low |
| | (60/40) | | (50/50) |

For example, when Bluetooth is on, the relatively low priority WLAN scanning state preferably results in granting a greater bandwidth allocation to Bluetooth, such as allowing all high priority Bluetooth transmissions, stomping low priority Bluetooth transmissions 40% of the time and stomping no Bluetooth transmissions the remaining 60% of the time. For the relatively higher priority WLAN associating state, all Bluetooth transmissions are stomped 60% of the time and low priority Bluetooth transmission are stomped the remaining 40% of the time.

Finally, if WLAN is connected and Bluetooth is on, it is preferable to allocate bandwidth based on the number of connected Bluetooth clients, their capabilities and the type of service required. This is indicated in Table 1 as being device dependent.

Generally, there are two types of Bluetooth links, SCO (Synchronous Connection-Oriented) and ACL (Asynchronous Connection-Less) link. Extended SCO (eSCO) links are similar to SCO links, but allow retransmission. The SCO link is a symmetric point-to-point link between a master and a single slave in which the SCO link is maintained by using reserved slots at regular intervals. Primarily, SCO links are used to carry voice information, such as in headset applications. An ACL link is a point-to-multipoint link between the master and associated slaves.

As will be appreciated, certain types of Bluetooth communications require high quality of service. For example, successful transmission of audio information, either bidirectionally for headset applications or unidirectionally for streaming music, has relatively low tolerance for packet loss or timing issues. Often, a combination of common characteristics associated with particular type of Bluetooth communication is specified in a corresponding profile For example, the Advanced Audio Distribution Profile (A2DP) is used for steaming high quality audio while the Headset Profile (HSP) and Hands-Free Profile (H P) are used to for communication with a mobile phone. Accordingly, the relative bandwidth allocations as well as the size of the time blocs can be configured to optimize the types of Bluetooth communications present.

Preferably, any or all of the above factors are used by multiplexer 108 to allocate bandwidth between the WLAN and Bluetooth systems. For example, in one embodiment a Bluetooth link using BDR is given a greater bandwidth allocation than an EDR link. Also preferably, the amount of bandwidth allocated to Bluetooth is limited to approximately 90%, otherwise the difficulties in maintaining a viable WLAN link may be too great. In one embodiment, the number and type of Bluetooth connections is used to allocate bandwidth as shown in Table 2.

TABLE 2

| | Period | BT allocation |
|---|---|---|
| SCO: 1, ACL: 0 | 40 ms | 50% |
| SCO: 0, ACL: 1 | 40 ms | 50% |
| SCO: 1, ACL: 1 | 40 ms | 60% |
| SCO: 0, ACL: 2 | 40 ms | 60% |
| SCO: 1, ACL: 2 | 40 ms | 70% |
| SCO: 0, ACL: 3 | 40 ms | 70% |
| SCO: 1, ACL: 3 | 40 ms | 80% |

As shown in FIG. 1, information about the transmission states of the WLAN and Bluetooth modules is conveyed by interface 118. In a preferred embodiment, interface 118 conforms to a conventional 3-wire PTA, or slotted mode, protocol, schematically illustrated in FIG. 4. WLAN hardware 104 and Bluetooth hardware 112 are linked by three wires. Bluetooth module 110 signals activity and priority to WLAN through the BT_active wire 402 and BT_priority wire 404, while WLAN module 102 signals WLAN activity using WLAN_active wire 406.

BT_active wire 402 indicates whether there is Bluetooth communication and BT_priority wire 404 indicates whether the communication is high or low priority. Optionally, BT_priority wire 404 is used to signal priority at the start of Bluetooth activity and subsequently used to indicate whether the activity is transmit or receive.

Under the 3-wire PTA protocol, the process of determining which system is granted access to the medium is carried out by the WLAN module, in the media access control (MAC) layer. The result of this arbitration is signaled using WLAN_active wire 406. Thus, multiplexer 108 modulates WLAN traffic to produce the desired bandwidth allocation over the time bloc while the PTA logic arbitrates access to the medium between WLAN and BT on a packet-by-packet basis in order to satisfy the desired allocation. For example, in a condition when both WLAN and Bluetooth are active, during segment 304 all Bluetooth traffic is allowed and any gaps are filled with WLAN traffic and during segment 306 all low priority Bluetooth traffic is blocked, high priority. Bluetooth traffic is allowed and WLAN traffic is allowed. The same techniques are applied to achieve the allocations discussed above during the other possible WLAN and Bluetooth states, such as WLAN association and Bluetooth management.

Alternatively, this disclosure can be applied to a 4-wire PTA protocol, wherein Bluetooth frequency fourth wire, used to indicate whether the communication is occurring on a restricted channel, is ground to zero Further details regarding the implementation of PTA techniques can be found in the IEEE 802.15 protocols.

Described herein are presently preferred embodiments. However, one skilled in the art that pertains to the present invention will understand that the principles of this disclosure can be extended easily with appropriate modifications to other applications.

What is claimed is:

1. A method for controlling WLAN and Bluetooth communications comprising the steps of:
a) providing a device having a WLAN module with a hardware portion, a Bluetooth module with a hardware portion, and a packet traffic interface between the WLAN hardware portion and the Bluetooth hardware portion;
b) dividing available communication bandwidth into time blocs;
c) allocating bandwidth in a time bloc into a first segment and a second segment;
d) assigning priority to Bluetooth communication for the first segment and assigning priority to WLAN communication for the second segment; and
e) signaling wireless access to the Bluetooth hardware portion through the interface during the first segment.

2. The method of claim 1, further comprising the step of modulating WLAN communication by signaling a WLAN access point to buffer transmission during the first segment.

3. The method of claim 2, wherein signaling the WLAN access point to buffer transmission comprises sending a power save signal.

4. The method of claim 1, further comprising the step of modulating WLAN communication by allowing reception of WLAN signals and blocking transmission of WLAN signals during the first segment.

5. The method of claim 1, wherein the step of allocating bandwidth is based upon information regarding Bluetooth links.

6. The method of claim 1, wherein the step of allocating bandwidth is based upon the state of the WLAN module and Bluetooth module.

7. The method of claim 1, further comprising the step of signaling wireless access to the Bluetooth hardware portion through the interface during the second segment so that high priority Bluetooth transmissions are allowed.

8. The method of claim 7, wherein the step of signaling wireless access to the Bluetooth hardware portion through the interface during the second segment does not allow low priority Bluetooth transmissions.

9. The method of claim 7, wherein the step of signaling wireless access to the Bluetooth hardware portion through the interface during the second segment allows low priority Bluetooth transmissions.

10. The method of claim 1, further comprising the step of transferring information between a software portion of the WLAN module and a software portion of the Bluetooth module with a coexistence agent.

11. The method of claim 10, wherein the information transferred by the coexistence agent is selected from the group consisting of information about the WLAN configuration state and information about the number and type of Bluetooth links.

12. An apparatus for controlling WLAN and Bluetooth communications including a device having a WLAN module with a hardware and software portion, a Bluetooth module with a hardware portion, and an packet traffic interface between the WLAN hardware portion and the Bluetooth hardware portion, wherein the WLAN software portion is configured to divide available communication bandwidth into time blocs, allocate bandwidth in a time bloc into a first segment and a second segment, assign priority to Bluetooth communication for the first segment and assign priority to WLAN communication for the second segment, and signal wireless access to the Bluetooth hardware portion over the interface during the first segment.

13. The apparatus of claim 12, wherein the WLAN software portion is further configured to modulate WLAN by signaling a WLAN access point to buffer transmission during the first segment.

14. The apparatus of claim 13, wherein the WLAN software portion signals the WLAN access point to buffer transmission by sending a power save signal.

15. The apparatus of claim 12, WLAN software portion is configured to modulate WLAN communication by allowing reception of WLAN signals and blocking transmission of WLAN signals during the first segment.

16. The apparatus of claim 12, wherein the WLAN software portion allocates bandwidth based upon information regarding Bluetooth links.

17. The apparatus of claim 12, wherein the WLAN software portion allocates bandwidth based upon the state of the WLAN module and Bluetooth module.

18. The apparatus of claim 12, wherein the WLAN software portion is further configured to signal wireless access to the Bluetooth hardware portion over the interface during the second segment so that high priority Bluetooth transmissions are allowed.

19. The apparatus of claim 18, wherein the WLAN software portion is further configured to signal wireless access to the Bluetooth hardware portion over the interface during the second segment so that low priority Bluetooth transmissions are not allowed.

20. The apparatus of claim 18, wherein the WLAN software portion is further configured to signal wireless access to the Bluetooth hardware portion over the interface during the second segment so that low priority Bluetooth transmissions are allowed.

21. The apparatus of claim 12, further comprising a coexistence agent configured to transfer information between the software portion of the WLAN module and a software portion of the Bluetooth module.

22. The apparatus of claim 21, wherein the information transferred by the coexistence agent is selected from the group consisting of information about the WLAN configuration state and information about the number and type of Bluetooth links.
